(19) United States
(12) Patent Application Publication
(10) Pub. No.: US 2016/0215538 A1
(43) Pub. Date: Jul. 28, 2016

(54) Door Stop With Vertical Stowaway Position

(71) Applicant: John C. Pistone, Davie, FL (US)

(72) Inventor: John C. Pistone, Davie, FL (US)

(21) Appl. No.: 15/004,352

(22) Filed: Jan. 22, 2016

Related U.S. Application Data
(60) Provisional application No. 62/108,320, filed on Jan. 27, 2015.

(51) Int. Cl. E05C 17/44

(52) U.S. Cl. CPC E05C 17/443

(57) ABSTRACT

A door and gate stop capable of stopping a door on a step-up threshold when, in a closed door position, the ground level clearance for the door is substantially nil and in an open door position, the ground level clearance exceeds at least three inches. The door stop is attached at a location on the door that is determined by the length of a stem member being able to effectively stop the door. The door stop stem member is pivotally connected to a base platform. The stem member is at least five inches or longer in length (typically 12 inches). A catch holds the door stem vertical to a door in a stowaway position when the door stop is not in use.

This is a regular, nonprovisional patent application titled Door Stop with Vertical Stowaway Position that claims the benefit of an earlier filed provisional application under 35 U.S.C. §119(e), provisional Application No. 62/108,320 filed Jan. 27, 2015 the contents of which is incorporated herein by reference thereto.

The present invention relates to a door and gate stop capable of stopping a door on a step-up threshold when, in a closed door position, the ground level clearance for the door is substantially nil and in an open door position, the ground level clearance exceeds at least three inches. The door stop is attached at a location on the door that is determined by the length of a stem member being able to effectively stop the door. The door stop stem member is rotatably connected to a base platform. The stem member is at least five inches in length, typically twelve inches or more. A catch holds the door stop vertical to a door in a stowaway position when the door stop is not in use.

As used herein, the term “door” includes any type of swinging or sliding barrier by which an entry is closed and opened into a building, structure, room or a “gate door” which can be opened to provide an entrance or an opening used for passage through a fence or wall. An example of a gate door is a side entrance to the back yard of a house. Another example of a gate door is a hinged door in the middle of a picket fence.

### BACKGROUND OF THE INVENTION

A door stop is an object or device used to hold a door or gate open or closed. Often times, a door stop is a short metal bar capped with rubber and is attached to a hinge near the bottom of a door. When the door is to be kept open, the bar is swung down so that the rubber end reaches the floor. Any attempt to move the door causes resistance from the rubber stopper and stops the door from moving. The stop is released by pushing the door slightly more open which releases the stop. A door stop can also be a rubber or wood wedge piece placed under the door when the door is in the desired position.

Most door stops are designed for doors or gates that are nearly adjacent to a floor with a nil ground level clearance. As used herein, ground level clearance means the distance from the bottom edge of the door to the surface of the ground. Typical door stops do not take into account the situation where the door construction includes a stoop, steps or is otherwise a good distance from the floor to which the door stop is intended to reach. In such instances, when the door is in an open position, there is a ground level clearance of at least three inches or more. This can occur where there is a stoop, step down, or the door is a fence or a swinging door that does not reach near the ground or has a significant gap between the bottom of the door and the floor or ground surface. Where there is a significant distance between the bottom of the door and the ground surface, a standard door stop will not work to hold the door in an open position. A standard door stop will not be able extend the increased distance to the ground surface (i.e. a ground level clearance of three inches or more) and therefore will not be able to hold the door in the desired position.

In such instances where a normal door stop does not work, because it does not reach the ground surface due to a significant distance between the bottom of the door edge and the ground surface, people have used many different items to hold the door open. The items include potted plants, bricks, rocks, landscaping objects, wooden blocks and/or wedges, poles or pieces of lumber, and furniture. These items are temporary solutions and often get in the way when entering through the door. Use of these items as temporary door stops are dangerous as they are not sturdy and tend to be heavy and likely to tip or fall over.

The current invention provides a door stop for use on a door with a step-up threshold and includes a vertical stowaway position which overcomes the forgoing disadvantages of the above mentioned door stops.

### OBJECTS OF THE INVENTION

It is an object of the present invention to provide a door or gate stop that is capable of being used on a door or gate with a step-up threshold that creates a significant gap between the bottom of the door and the ground surface or floor to which the door stop is intended to reach. The door stop of the invention will work in instances where in a closed door position, the ground level clearance is nil and in an open door position, the ground level clearance exceeds at least three inches or more.

It is also an object of the present invention to provide a door stop that will work with both a door that is adjacent a ground surface as well as a door that has a significant gap between the bottom of the door and the ground surface. It is an object of the present invention to provide a door stop that may be actuated without a user bending too far over.

It is a further object of the present invention to provide a door stop that is capable of being securely stowed away on the door until needed.

### SUMMARY OF THE INVENTION

The present invention provides a door stop or gate stop capable of stopping a door on a step-up threshold when, in a closed door position, the ground level clearance for the door is substantially nil and in an open door position, the ground level clearance exceeds at least three inches. The door stop has a base platform adapted to be attached to a door and a stem member pivotally connected to the base platform. The stem member is rotatable down to a ground surface to hold the door in a certain position. The door stop includes a catch for holding the door stop vertical to a door in a stowaway position. The catch has one or more notches in opposing sides of the upper portion of the base platform for receiving one or more pins located on opposing sides of the stem member. The stem member is rotated upward to a position vertical to the door and the pins of the stem member are set in the notches. The base platform is attached at a location on the door which location is determined by a length of a stem member being able to reach the ground surface and effectively stop the door.

The present invention provides a door stop or gate stop capable of stopping a door on a step-up threshold when, in a closed door position, the ground level clearance for the door is substantially nil and in an open door position, the ground level clearance exceeds at least three inches. A plate is adapted to be attached to a door at a location on the door that is determined by a length of a stem member being able to reach the ground surface and effectively stop the door. A base platform contains one or more notches on the upper portion and one or more slots on the lower portion. The base platform has a vertical interior channel for receiving a proximal portion of the stem member. A stem member is pivotally connected to the base platform. The stem member is at least five inches in length to extend the ground level clearance distance when the door is in an open position. There are one or more rods on the stem member proximal to the base platform. The stem member is pivotally connected to the base platform by the rods being retained in the slots of the base platform. There are one or more pins on the stem member proximal to the base platform. The door stop includes a catch for holding the door stop vertical to a door, wherein the notches receive the pins when the stem member is rotated upward to a position vertical to the door and the pins of the stem member are set in the notches. The slots permit the rods to have a slight vertical movement within the slots when the stem is lifted so that the pins can be set into the notches when the stem is put in a stowaway position. The slight vertical movement of the rods within the slots also occurs when the stem is lifted and the pins removed from the notches so that the stem can be lowered into a position that allows it to effectively stop a door from moving.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description when taken in conjunction with the accompanying drawings.

FIG. 1 is a side view of the door stop in the extended stop position.

FIG. 2 is a side view of the door stop in a stowaway position.

FIG. 3 is a perspective view of the door stop in the extended stop position.

### DETAILED DESCRIPTION OF THE PREFERRED EMBODIMENTS

Referring now to the drawings, the invention will be described in more detail. It is important to note that the embodiments of the invention described below are only examples of the several advantageous uses of the innovative teachings described herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

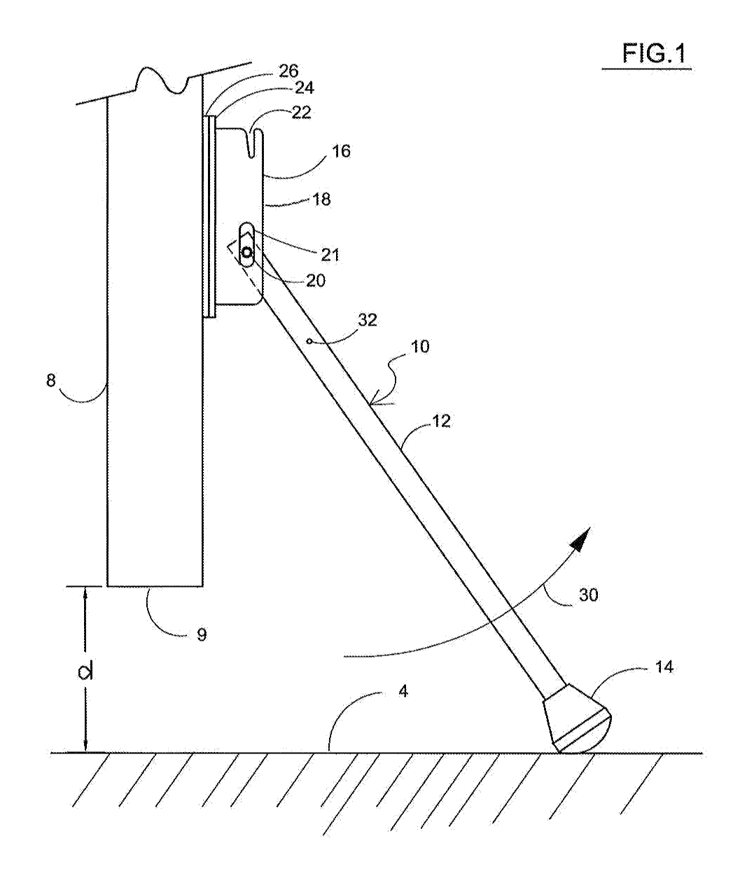

FIG. 1 is a side view of the door stop 10 in the extended stop position. The term door 8 includes typical doors both internal and external to a building, gate doors, gate swing doors and any other type of doors where there is a ground level clearance of at least three inches when the door is in an open position, such as a door on a step-up threshold. A step-up threshold is present when there is little or no (nil) space between a ground plane 4 and the bottom edge 9 of the door 8 when the door 8 is in a closed position, but when the door 8 is in an open position, the ground level clearance distance d is much greater, typically more than 3 inches. Stated otherwise, when the door 8 is open, there is at least three inches clearance between the bottom of the door edge 9 and the ground plane level 4.

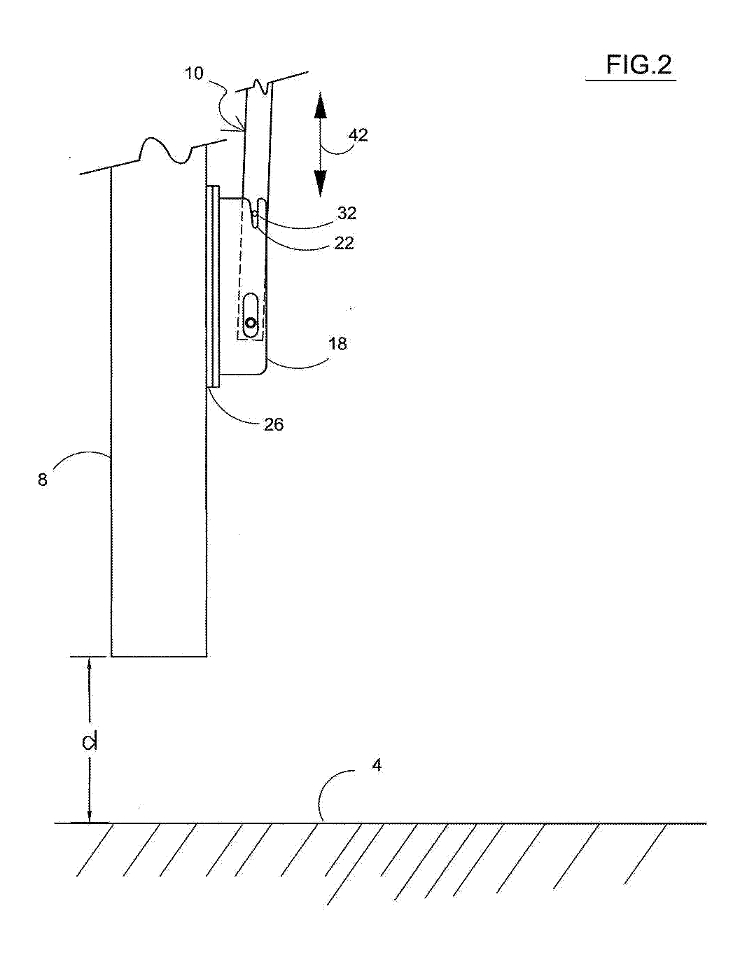

The door stop 10 has an extended position (as shown in FIG. 1) and a vertical stowaway position (as shown in FIG. 2). The door stop 10 has a base platform 16, attached in some manner to the door 8, and a movable stem member 12, which is pivotally hinged to the base platform 16. The door stop stem member 12 is ideally between five inches (5″) to eighteen inches (18″) in length, which is significantly longer than a regular door stop stem. Typically, the stem member is at least twelve inches (12″) in length. The longer stem member 12 allows the door stop 10 to extend over a significant ground level clearance distance d to accommodate a step or stoop. The terminal end of stem member 12 optionally has a grip element 14 which rests on a ground surface 4 when the stop is locking the door in an open position. Alternatively, the door stop 10 can lock the door 8 closed, when the door 8 is closed against a doorjamb. One benefit of having a stem member 12 at least 5″ or more in length is that the user does not have to bend too far over to actuate the door stop 10, because the stem member 12 will always be well within reach of the user due to the increased length of the stem member 12.

An important feature is that the door stop 10 can be used when the door 8 has a varied ground level clearance distance d over the ground surface 4. Distance d is the distance between the lower edge of the door and the ground plane 4. The ground level clearance distance d includes instances where the terminal bottom edge 9 of the door 8 is significantly above ground surface 4, such as doors that have a step-down threshold, steps down, a stoop, a self closing door, fences and gates. The door stop 10 is capable of stopping a door 8 on a step-up threshold when, in a closed door 8 position, the ground level clearance distance d for the door 8 is substantially nil and in an open door 8 position, the ground level clearance distance d exceeds at least three inches. The base platform 16 of the door stop 10 is attached to a plate 24 which is attached to the door 8 at a point that allows the extra long stem member 12 of the door stop 10 to extend and reach the ground surface 4. Thus, the door stop 10 can function with all types of doors, even doors 8 where the ground level clearance distance d is less than an inch. In such a case, where the door 8 is just above the ground surface 4, the base platform 16 is placed at a location higher up on the door 8. Thus, the door stop 10 of the invention will work with doors 8 that have a ground level clearance of nearly nil and doors 8 that have a significant ground level clearance distance d. The ground level clearance distance d to the ground surface 4 determines the attachment location of the door stop 10 on the door 8. The door stop 10 is adapted to be attachable to a door 8 at a location where the length of a stem member 12 is able to reach the ground surface 4 and effectively stop the door 8.

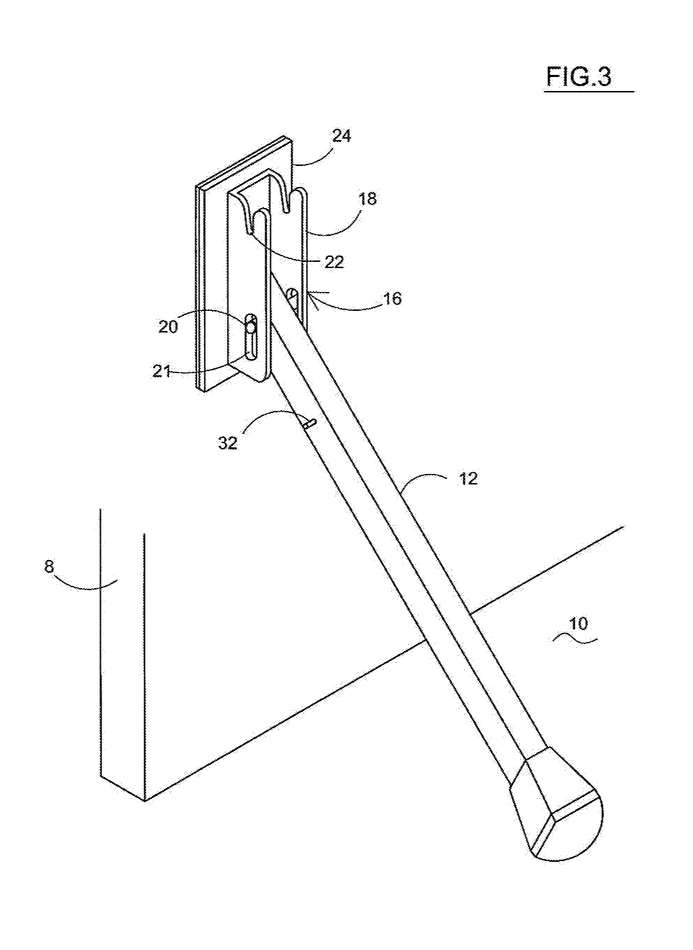

Referring to FIGS. 1, 2 and 3, base platform 16 has, at an upper portion, a plurality of notches 22 for catching and stowing away the door stop 10 when it is not in use. Only one notch 22 is shown in FIGS. 1 and 2, however, a second notch is behind slot 22 as shown in FIG. 3. The same is true for the other reciprocal elements, namely, there are two notches 22 on opposing sides of the upper portion of the base platform 16, there are two pins 32 located on opposing sides of the stem member 12, there are two slots 21 on opposing sides of the lower portion of the base platform 16, and there are two rods 20 extending from opposing sides of the stem member. In the preferred embodiment, there are two notches 22, two slots 21, two rods 20 and two pins 32, each on opposing sides of the stem member, however it shall be understood that an additional number of slots, notches pins and rods could be added without deviating from the spirit of the invention.

The door stop stem member 12 has a at least one rod 20 on the stem member 12 proximal to the base platform 16, which are retained in slots 21 which secures the stem member 12 on the base platform 16 and allows the stem member 12 to pivot or rotate to a downward and upward position. The door stop stem member 12 rotates or pivots about rods 20 in slots 21, which allows the door stop 10 to rotate down for use to stop a door or up to be stowed away (as shown by arrow 30). The slots 21 permit the rods 20 to have a slight play or vertical movement within slots 21 when the stem member 12 is lifted so that pins 32 can be set into notches 22 when the stem member 12 is put in a stowaway position. The slight play or vertical movement of the rods 20 within slots 21 also permit the stem member 12 to be lifted so that the pins 32 can be removed from the notches 22 when the stem member 12 is removed from a stowaway position. Generally, the base platform 16 has a plate 24 and a channel element 18. The channel element 18 is an open vertical interior channel that receives the proximal portion of stem member 12. Open notches 22 in the base platform 16 captures pins 32 on the stem member 12 proximal to the base platform 16, when the stem member 12 is put in a vertical position against the door 8. See FIG. 2. The plate 24 may have an adhesive layer 26 to attach the door stop 10 to the door. Additionally or alternatively screws or other attachment systems may be used to mount plate 24 to the door 8.

As shown in FIG. 2, to stowaway and lock the door stop 10, the user rotates stem member 12 in the direction of arrow 30 until the stem member 12 is vertical and parallel to the door 8 as shown in FIG. 2. The stem member 12 has pins 32 on the stem member 12 proximal to the base platform 16 which cooperates with upper notches 22. The stem member 12 is slightly lifted in the vertical direction and then the stem member 12 is pushed downward in the direction of arrow 42 so that pins 32 move vertically into notches 22 and thereby lock the stem in stowaway position. This holds the door stop 10 securely out of the way until it is needed. To use the door stop 10, the user simply lifts the pins 32 out of the notches 22 and thereby releases the door stem member 12 which can then rotate in the direction of the ground surface 4.

The door stop stem member 12 can be made of any known, suitable materials, such as metal, plastic or wood. The grip element 14 is any suitable material that serves to reduce friction and stop the door from moving, such as rubber or a synthetic material. The door stop is easy to use and does not require the user to bend over too far. The catch mechanism securely holds the door stop in a stowaway position, even when the door is slammed shut. The door stop may be constructed with only a few parts, which makes it inexpensive to manufacture and relatively easy to install and use. The door stop is preferably made of weather resistant parts, so that exposure to the elements will not affect its function.

FIG. 3 is a perspective view showing the door stop 10 in the extended position stopping a door 8 in an open position. Plate 24 attaches the door stop 10 to the door 8. Plate 24 is optional. The base platform 16 is shown attached to plate 24. The plate 24 and base platform 16 can be one unitary piece or soldered, screwed, or otherwise attached together. The base platform 16 is composed of two rectangular edge pieces or edge plates laying perpendicular to the plate 24, a connecting piece that lies parallel to the plate 24 and connects the two rectangular edge pieces, and which form a vertical interior open square channel 18 between the two pieces or plates. The base platform 16 can be optionally attached directly to the door 8 by any known attachment means, such as screws. The terminal end of the stem member 12 is set within the channel 18 between the two vertical edge plates. The stem member 12 is held in the channel 18 by rods 20, which are received in slots 21. The stem 12 pivots or rotates about the rods 20, which allows the stem member 12 to rotate to a downward, stopping position or an upward stowaway position. The terminal end section of the stem is captured between the vertical edge plates. See FIG. 2. Pins 32 are on the upper segment or portion of the stem member 12 proximal the door 8 and base platform 16. Pins 32 are about one inch from the end of the stem member 12 proximal to the base platform 16. Pins 32 are located on the outer facing side of the stem member 12. Open notches 22 in the base platform 16 capture pins 32 when the stem member 12 is rotated or pivoted upward to a vertical position against the door 8 and slightly lifted into notches 22.

Additionally, the door stop 10 can be used as a security device to double lock the door 8 when the door 8 is closed in the door jamb. Extension of the door stop 10 when the door 8 is in the closed position would make it difficult if not impossible to open the door 8.

The base plate 24 is optional. In such embodiments where a base plate 24 is not used to attach the door stop 10 to a door 8, the base platform 16 is attached directly to the door 8. The base platform 16 is composed of two rectangular edge pieces or edge plates laying perpendicular to the door 8, a connecting piece that lies parallel to the door 8 and connects the two rectangular edge pieces. The base platform 16 forms a vertical interior open square channel 18 between the two pieces or plates. When a base plate 24 is not used, the base platform 16 is attached directly to the door 8 by any known attachment means, such as screws.

Alternatively, the door stop may be installed on both sides of the door, both inside and outside. This configuration allows a door to be held stationary at virtually any position.

While the preferred embodiment of the invention has been described using specific terms, such description is for illustrative purposes only, and it is to be understood that changes and variations may be made without departing from the spirit or scope of the following claims. The claims appended hereto are meant to cover modifications and changes within the scope and spirit of the present invention.

What is claimed is:

1. A door stop capable of stopping a door on a step-up threshold when, in a closed door position, the ground level clearance between the door and a ground surface is substantially nil and in an open door position, the ground level clearance exceeds at least three inches, the door stop comprising:
a base platform adapted to be attached to said door;
a stem member pivotally connected to the base platform, the stem member being rotatable down to said ground surface to hold the door in a certain open door position;
a catch for holding the door stop stem member vertical to said door, the catch having one or more notches in opposing sides of the upper portion of the base platform for receiving one or more pins located on opposing sides of the stem member, wherein the stem member is rotated upward to a position vertical to the door, and the pins of the stem member are set in the notches; and
wherein the base platform is adapted to be attached at a lower door location that is determined by a length of a stem member being able to reach the ground surface and effectively stop the door when in the open door position.

2. The door stop of claim 1, further comprising at least one rod extending from opposing sides of the stem member proximal to the base platform, the stem member being pivotally connected to the base platform by the at least one rod which is retained in corresponding slots on a lower portion of the base platform.

3. The door stop of claim 2, wherein the at least one rod moves vertically within the slots when the stem is lifted so that the catch pins can be set into the notches when the stem is put in a stowaway position.

4. The door stop of claim 1, further containing a grip element on the terminal end of the stem member.

5. The door stop of claim 1, wherein the stem member is at least five inches in length.

6. The door stop of claim 1, wherein the base platform is attached to the door by an adhesive layer.

7. The door stop of claim 1, wherein the base platform is attached to a plate, which is adapted to be attachable to the door.

8. The door stop of claim 1, wherein the base platform forms a vertical interior channel for receiving an terminal end portion of the stem member.

9. A door stop capable of stopping a door on a step-up threshold when, in a closed door position, the ground level clearance for a door is substantially nil and in an open door position, the ground level clearance exceeds at least three inches, comprising:
a plate adapted to be attached to said door, the plate attached at a location on the door which location is determined by a length of a stem member being able to reach a ground surface and effectively stop the door in the open position;
a base platform, the base platform containing one or more notches on the upper portion of the base platform and one or more slots on the lower portion of the base platform and the base platform forming a vertical interior channel for receiving an end portion of the stem member;
a stem member pivotally connected to the base platform, the stem member being at least five inches in length;
one or more rods on the stem member proximal to the base platform, the stem member being pivotally connected to the base platform by the rods being retained in the slots of the base platform;
one or more pins on the stem member proximal to the base platform; and
a catch for holding the door stop vertical to the door, wherein the notches receive the pins when the stem member is rotated upward to a position vertical to the door and the pins of the stem member are set in the notches.

10. The door stop of claim 9, wherein the slots permit the one or more rods to have a limited vertical movement within the slots when the stem is lifted so that the pins can be set into the notches when the stem is put in a stowaway position.

11. The door stop of claim 10, wherein a length of the slots is larger than the length of the notches thereby permiting the rods to have said limited vertical movement within the slots when the stem is lifted so that the pins can be set into the notches when the stem is put in a stowaway position.

12. The door stop of claim 9, wherein the slots permit the one or more rods to have a limited vertical movement within the slots when the stem member is lifted so that the pins can be removed from the notches when the stem is removed from a stowaway position.

13. The door stop of claim 9, further containing a grip element on the terminal end of the stem member.

14. The door stop of claim 9, wherein the plate is adapted to the door by an adhesive layer.

15. The door stop of claim 9, wherein the plate is adapted to the door by screws.
